(19) United States
(12) Patent Application Publication
(10) Pub. No.: US 2008/0002304 A1
(43) Pub. Date: Jan. 3, 2008

(54) Micro-actuator mounting arrangement and manufacturing method thereof

(75) Inventors: MingGao Yao, DongGuan (CN); YiRu Xie, DongGuan (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 11/477,660

(22) Filed: Jun. 30, 2006

(51) Int. Cl. G11B 21/24

(52) U.S. Cl. 360/294.4

(57) ABSTRACT

A micro-actuator for a head gimbal assembly includes a metal frame including a top support having a top surface adapted to support a slider, a bottom support having a bottom surface adapted to be mounted to a suspension, and a pair of side arms that interconnect the top support and the bottom support. Each of the side arms includes an outwardly facing surface adapted to be mounted to a PZT element. The top surface, the bottom surface, and/or the outwardly facing surface includes a partially etched notch.

### FIELD OF THE INVENTION

The present invention relates to information recording disk drive devices and, more particularly, to a micro-actuator for a head gimbal assembly (HGA) of the disk drive device.

### BACKGROUND OF THE INVENTION

One known type of information storage device is a disk drive device that uses magnetic media to store data and a movable read/write head that is positioned over the media to selectively read from or write to the disk.

Consumers are constantly desiring greater storage capacity for such disk drive devices, as well as faster and more accurate reading and writing operations. Thus, disk drive manufacturers have continued to develop higher capacity disk drives by, for example, increasing the density of the information tracks on the disks by using a narrower track width and/or a narrower track pitch. However, each increase in track density requires that the disk drive device have a corresponding increase in the positional control of the read/write head in order to enable quick and accurate reading and writing operations using the higher density disks. As track density increases, it becomes more and more difficult using known technology to quickly and accurately position the read/write head over the desired information tracks on the storage media. Thus, disk drive manufacturers are constantly seeking ways to improve the positional control of the read/write head in order to take advantage of the continual increases in track density.

One approach that has been effectively used by disk drive manufacturers to improve the positional control of read/write heads for higher density disks is to employ a secondary actuator, known as a micro-actuator, that works in conjunction with a primary actuator to enable quick and accurate positional control for the read/write head. Disk drives that incorporate a micro-actuator are known as dual-stage actuator systems.

Various dual-stage actuator systems have been developed in the past for the purpose of increasing the access speed and fine tuning the position of the read/write head over the desired tracks on high density storage media. Such dual-stage actuator systems typically include a primary voice-coil motor (VCM) actuator and a secondary micro-actuator, such as a PZT element micro-actuator. The VCM actuator is controlled by a servo control system that rotates the actuator arm that supports the read/write head to position the read/write head over the desired information track on the storage media. The PZT element micro-actuator is used in conjunction with the VCM actuator for the purpose of increasing the positioning access speed and fine tuning the exact position of the read/write head over the desired track. Thus, the VCM actuator makes larger adjustments to the position of the read/write head, while the PZT element micro-actuator makes smaller adjustments that fine tune the position of the read/write head relative to the storage media. In conjunction, the VCM actuator and the PZT element micro-actuator enable information to be efficiently and accurately written to and read from high density storage media.

One known type of micro-actuator incorporates PZT elements for causing fine positional adjustments of the read/write head. Such PZT micro-actuators include associated electronics that are operable to excite the PZT elements on the micro-actuator to selectively cause expansion or contraction thereof. The PZT micro-actuator is configured such that expansion or contraction of the PZT elements causes movement of the micro-actuator which, in turn, causes movement of the read/write head. This movement is used to make faster and finer adjustments to the position of the read/write head, as compared to a disk drive unit that uses only a VCM actuator. Exemplary PZT micro-actuators are disclosed in, for example, JP 2002-133803, entitled “Micro-actuator and HGA” and JP 2002-074871, entitled “Head Gimbal Assembly Equipped with Actuator for Fine Position, Disk Drive Equipped with Head Gimbals Assembly, and Manufacture Method for Head Gimbal Assembly.” Other exemplary PZT micro-actuators are also disclosed in, for example, U.S. Pat. Nos. 6,671,131 and 6,700,749.

FIGS. 1 and 2 illustrate a conventional disk drive unit and show a magnetic disk 101 mounted on a spindle motor 102 for spinning the disk 101. A voice coil motor arm 104 carries a head gimbal assembly (HGA) 100 that includes a micro-actuator 105 with a slider 103 incorporating a read/write head. A voice-coil motor (VCM) is provided for controlling the motion of the motor arm 104 and, in turn, controlling the slider 103 to move from track to track across the surface of the disk 101, thereby enabling the read/write head to read data from or write data to the disk 101.

FIG. 3 illustrates the head gimbal assembly (HGA) 100 of the conventional disk drive device of FIGS. 1 and 2 incorporating a dual-stage actuator. However, because of the inherent tolerances of the VCM and the head suspension assembly, the slider 103 cannot achieve quick and fine position control which adversely impacts the ability of the read/write head to accurately read data from and write data to the disk. As a result, a PZT micro-actuator 105, as described above, is provided in order to improve the positional control of the slider and the read/write head. More particularly, the PZT micro-actuator 105 corrects the displacement of the slider 103 on a much smaller scale, as compared to the VCM, in order to compensate for the resonance tolerance of the VCM and/or head suspension assembly. The micro-actuator 105 enables, for example, the use of a smaller recording track pitch, and can increase the “tracks-per-inch” (TPI) value by 50% for the disk drive unit, as well as provide an advantageous reduction in the head seeking and settling time. Thus, the PZT micro-actuator 105 enables the disk drive device to have a significant increase in the surface recording density of the information storage disks used therein.

As shown in FIGS. 3 and 4, the HGA 100 includes a suspension 106 having a suspension tongue 108 to load the PZT micro-actuator 105 and the slider 103. Suspension traces 110 are provided on opposite sides of the suspension tongue 108.

Referring to FIG. 5, a conventional PZT micro-actuator 105 includes a metal frame 130 which has a top support 132, a bottom support 134, and two side arms 136, 138 that interconnect the two supports 132 and 134. The side arms 136, 138 each have a PZT element 140, 142 mounted on an outer surface for actuation. The slider 103 is supported on the top support 132.

Referring to FIG. 4, the PZT micro-actuator 105 is physically coupled to the suspension tongue 108 by the bottom support 134 of the frame 130. The bottom support 134 may be mounted on the suspension tongue 108 by epoxy or adhesive, for example. Multiple connection balls, e.g., three electrical connection balls 150 (gold ball bonding or solder ball bonding, GBB or SBB), are provided to couple the PZT micro-actuator 105 to the suspension traces 110 located at the side of each PZT element 140, 142. In addition, there are multiple connection balls, e.g., four electrical connection balls 152 (GBB or SBB), for coupling the slider 103 to the suspension traces 110 for electrical connection of the read/write transducers. When power is supplied through the suspension traces 110, the PZT elements 140, 142 expand or contract to cause the two side arms 136, 138 to bend in a common lateral direction. The bending causes a shear deformation of the frame 130, e.g., the rectangular shape of the frame becomes approximately a parallelogram, which causes movement of the top support 132. This causes movement or lateral translation of the slider 103 connected thereto, thereby making the slider 103 move on the track of the disk in order to fine tune the position of the read/write head. In this manner, controlled displacement of slider 103 can be achieved for fine positional tuning.

Mounting a PZT element to each side arm of the metal frame is difficult since the width of the side arm is limited and the roughness of the metal surface is relatively small. Also, using epoxy or adhesive for mounting may not provide sufficient mounting strength for HGA manufacturing requirements. For example, the PZT element may detach during the manufacturing process, the electrical connection process with the suspension traces, and/or mechanical shock or vibration. Also, reliability may be a concern due to the micro-actuator being an active device. In addition, since the metal surface of the metal frame is relatively smooth, the mounting strength between the micro-actuator and the suspension tongue may not be sufficient. This may also affect the electrical connection process and/or HGA performance.

Thus, there is a need for an improved system that does not suffer from the above-mentioned drawbacks.

### SUMMARY OF THE INVENTION

One aspect of the present invention relates to a micro-actuator mounting arrangement to improve the micro-actuator mounting strength for the head gimbal assembly (HGA) of the disk drive device.

Another aspect of the invention relates to a micro-actuator for a head gimbal assembly. The micro-actuator includes a metal frame including a top support having a top surface adapted to support a slider, a bottom support having a bottom surface adapted to be mounted to a suspension, and a pair of side arms that interconnect the top support and the bottom support. Each of the side arms includes an outwardly facing surface adapted to be mounted to a PZT element. The top surface, the bottom surface, and/or the outwardly facing surface includes a partially etched notch.

Another aspect of the invention relates to a head gimbal assembly including a micro-actuator, a slider, and a suspension that supports the micro-actuator and the slider. The micro-actuator includes a metal frame including a top support having a top surface that supports the slider, a bottom support having a bottom surface mounted to the suspension, and a pair of side arms that interconnect the top support and the bottom support. Each of the side arms includes an outwardly facing surface adapted to be mounted to a PZT element. The top surface, the bottom surface, and/or the outwardly facing surface includes a partially etched notch.

Another aspect of the invention relates to a disk drive device including a head gimbal assembly, a drive arm connected to the head gimbal assembly, a disk, and a spindle motor operable to spin the disk. The head gimbal assembly includes a micro-actuator, a slider, and a suspension that supports the micro-actuator and slider. The micro-actuator includes a metal frame including a top support having a top surface that supports the slider, a bottom support having a bottom surface mounted to the suspension, and a pair of side arms that interconnect the top support and the bottom support. Each of the side arms includes an outwardly facing surface adapted to be mounted to a PZT element. The top surface, the bottom surface, and/or the outwardly facing surface includes a partially etched notch.

Yet another aspect of the invention relates to a method for manufacturing a micro-actuator frame. The method includes forming a metal sheet that includes multiple interconnected row bars with each row bar including multiple interconnected frame units, cutting a single row bar from the metal sheet, cutting a single frame unit from the single row bar, forming the single frame unit into a micro-actuator frame by vertically bending opposing sides of the single frame unit to form side arms, cleaning the micro-actuator frame, visually inspecting the micro-actuator frame, and packing the micro-actuator frame.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 is a perspective view of a conventional disk drive unit;

FIG. 2 is a partial perspective view of the conventional disk drive unit shown in FIG. 1;

FIG. 3 is a perspective view of a conventional head gimbal assembly (HGA);

FIG. 4 is an enlarged, partial perspective view of the HGA shown in FIG. 3;

FIG. 5 is a perspective view of a slider and PZT micro-actuator of the HGA shown in FIG. 3;

FIG. 6 is a top view of a head gimbal assembly (HGA) including a PZT micro-actuator according to an embodiment of the present invention;

FIG. 7 is an exploded view of a portion of the HGA shown in FIG. 6;

FIG. 8 is a top perspective view of a micro-actuator frame according to an embodiment of the present invention;

FIG. 9 is a top perspective view of the micro-actuator frame shown in FIG. 8 from a different angle;

FIG. 10 is a bottom perspective view of the micro-actuator frame shown in FIG. 8;

FIG. 11 is an exploded view of the PZT micro-actuator shown in FIG. 6 showing the micro-actuator frame and PZT elements;

FIG. 12 shows peel strength testing data for a prior art micro-actuator without partially etched notches in the side arms;

FIG. 13 shows peel strength testing data for the PZT micro-actuator shown in FIG. 6 with partially etched notches in the side arms;

FIG. 14 shows testing data of the relationship between micro-actuator stroke and partial etching depth for the PZT micro-actuator shown in FIG. 6;

FIG. 15 shows testing data of the relationship between micro-actuator resonance and partial etching depth for the PZT micro-actuator shown in FIG. 6;

FIG. 16 is a flow chart illustrating a manufacturing process according to an embodiment of the present invention;

FIGS. 17a-17e are sequential views illustrating the manufacturing process shown in FIG. 16; and

FIGS. 18-21 are top perspective views of micro-actuator frames including partially etched notches according to alternative embodiments of the present invention.

### DETAILED DESCRIPTION OF ILLUSTRATED EMBODIMENTS

Various embodiments of the present invention will now be described with reference to the figures, wherein like reference numerals designate similar parts throughout the various views. As indicated above, an aspect of the present invention is to improve the micro-actuator mounting strength for the head gimbal assembly (HGA) of the disk drive device. By improving the micro-actuator mounting strength of the HGA, the dynamic performance characteristics of the disk drive device are improved.

Several example embodiments of a micro-actuator for a HGA will now be described. It is noted that the micro-actuator may be implemented in any suitable disk drive device having a micro-actuator in which it is desired to improve micro-actuator mounting strength, regardless of the specific structure of the HGA as illustrated in the figures. That is, the invention may be used in any suitable device having a micro-actuator in any industry.

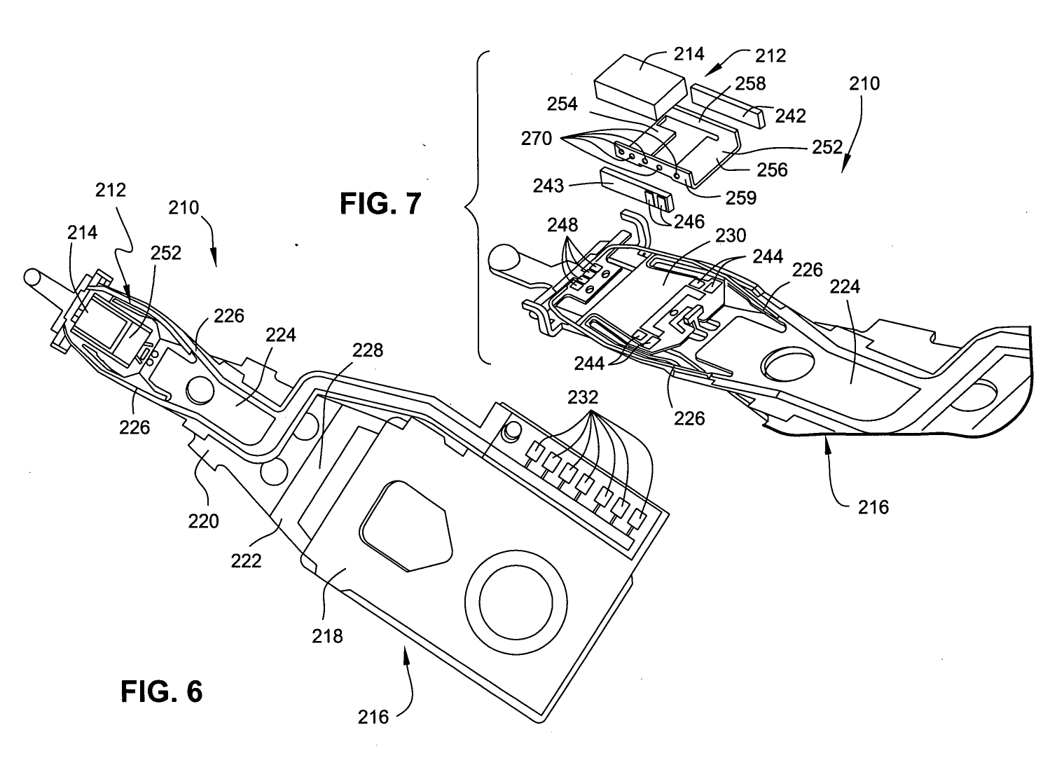

FIGS. 6-7 illustrate a head gimbal assembly (HGA) 210 incorporating a PZT micro-actuator 212 according to an embodiment of the present invention. The HGA 210 includes a PZT micro-actuator 212, a slider 214, and a suspension 216 to support the PZT micro-actuator 212 and the slider 214.

As illustrated, the suspension 216 includes a base plate 218, a load beam 220, a hinge 222, a flexure 224, and suspension traces 226 in the flexure 224. The base plate 218 is constructed of a relatively hard or rigid material, e.g., metal, to stably support the suspension 216 on a drive arm of a voice coil motor (VCM).

The hinge 222 is mounted onto the base plate 218 and load beam 220, e.g., by welding. As illustrated, the hinge 222 includes a holder bar 228 for supporting the load beam 220.

The flexure 224 is mounted to the hinge 222 and the load beam 220, e.g., by lamination or welding. The flexure 224 provides a suspension tongue 230 to couple the PZT micro-actuator 212 to the suspension 216. Also, the suspension traces 226 are provided on the flexure 224 to electrically connect a plurality of connection pads 232 (which connect to an external control system) with the slider 214 and the PZT elements 242, 243 on the PZT micro-actuator 212.

Bonding pads 244 are directly connected to the suspension traces 226 to electrically connect the suspension traces 226 with bonding pads 246 provided on the PZT elements 242, 243. Also, bonding pads 248 are directly connected to the suspension traces 226 to electrically connect the suspension traces 226 with bonding pads provided on the slider 214.

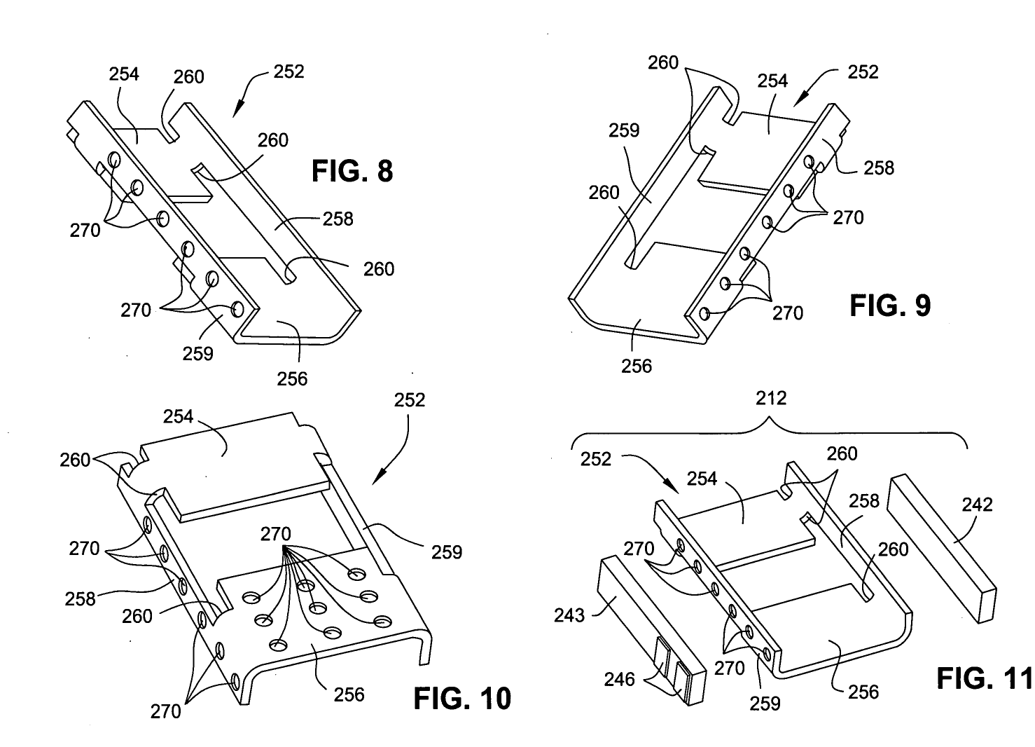

FIGS. 8-11 illustrate the PZT micro-actuator 212 removed from the slider 214 and the suspension 216. As illustrated, the PZT micro-actuator 212 includes a micro-actuator frame 252 and PZT elements 242, 243 mounted to respective side arms of the frame 252.

The frame 252 includes a top support 254, a bottom support 256, and side arms 258, 259 that interconnect the top support 254 and bottom support 256. The frame 252 is preferably constructed of a metal material, however other suitable materials are possible.

The side arms 258, 259 are vertically formed from opposing sides of the top and bottom supports 254, 256. As illustrated, inner spaces 260 exist between the top and bottom supports 254, 256 and respective side arms 258, 259. This arrangement provides the side arms 258, 259 with a longer active length and will allow the side arms 258, 259 more freedom of movement.

As best shown in FIGS. 8-11, multiple notches or indentations 270 are formed, e.g., by partial etching, in the outside surface of each side arm 258, 259 and in the bottom surface of the bottom support 256. In the illustrated embodiment, six partially etched notches 270 are provided in each side arm 258, 259 along its length (e.g., see FIGS. 8-11), and nine partially etched notches 270, e.g. three rows of three notches, are provided in the bottom support 256 (e.g., see FIG. 10). However, other suitable numbers and arrangement of notches may be provided.

Also, in the illustrated embodiment, each notch 270 is in the form of a partially etched dot. However, each notch 270 may have other suitable shapes as described below. The depth of each partially etched notch 270 is about 1-20 μm. The multiple notches 270 in the side arms 258, 259 are provided to increase the mounting strength between the side arms 258, 259 and the PZT elements 242, 243, and the multiple notches 270 in the bottom support 256 are provided to increase the mounting strength between the bottom support 256 and the suspension tongue 230.

In another embodiment (not shown), multiple notches or indentations 270 may also be formed in a top surface of the top support 254, e.g., by partial etching. The multiple notches 270 in the top surface of the top support 254 are provided to increase the mounting strength between the top support 254 and the slider 214 of the micro-actuator 212.

A PZT element 242, 243 is mounted to an outwardly facing surface of a respective side arm 258, 259 of the frame 252. Bonding pads 246, e.g., two pads, are provided on each PZT element 242, 243 for electrically connecting each PZT element 242, 243 to the suspension traces 226 using, for example, electrical connection balls (GBB or SBB). The PZT elements 242, 243 may be mounted to respective side arms 258, 259 by epoxy or adhesive for example. The partially etched notches or dots 270 in the side arms 258; 259 increase the surface roughness of the side arms 258, 259 which increases the mounting strength between the PZT elements 242, 243 and respective side arms 258, 259. The increased mounting strength will improve micro-actuator and HGA performance.

The bottom support 256 is structured to connect the micro-actuator frame 252 to the suspension 216. Specifically, the bottom support 256 is mounted to the suspension tongue 230 of the flexure 224, e.g., by epoxy, resin, or welding. The partially etched notches or dots 270 in the bottom support 256 increase the surface roughness of the bottom support 256 which increases the mounting strength between the suspension tongue 230 and the bottom support 256. The increased mounting strength will improve micro-actuator and HGA performance.

The top support 254 is structured to connect the frame 252 to the slider 214. Specifically, the slider 214 is partially mounted on the top support 254. As noted above, partially etched notches or dots 270 may be provided in the top support 254 to increase the surface roughness of the top support 254 which increases the mounting strength between the top support 254 and the slider 214 of the micro-actuator 212. Multiple bonding pads provided on the slider 214 are electrically bonded with respective pads 248 using, for example, electric connection balls (GBB or SBB). This connects the top support 254 to the slider 214 and electrically connects the slider 214 and its read/write elements to the suspension traces 226 on the suspension 216.

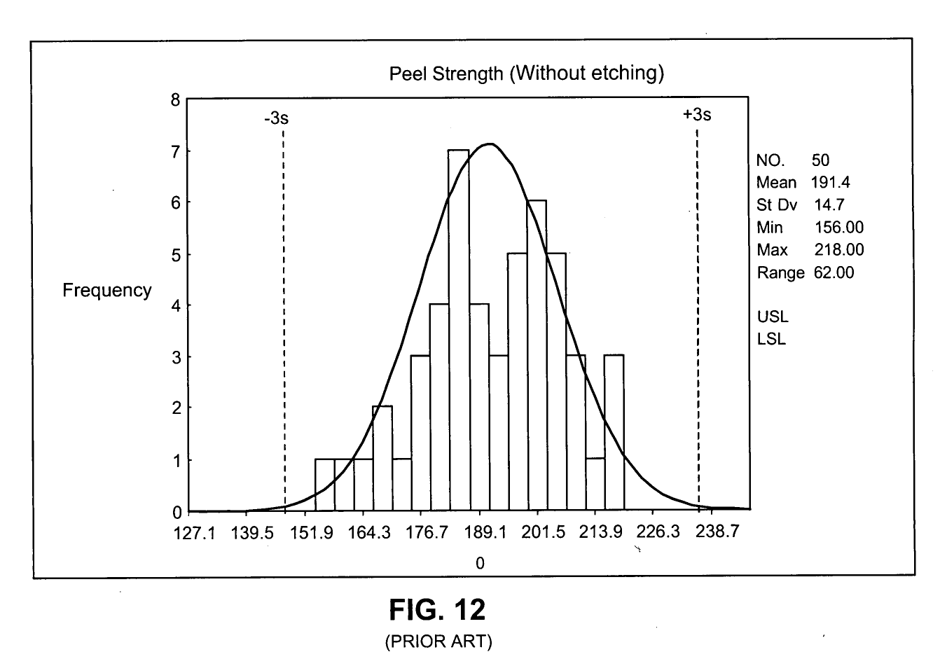

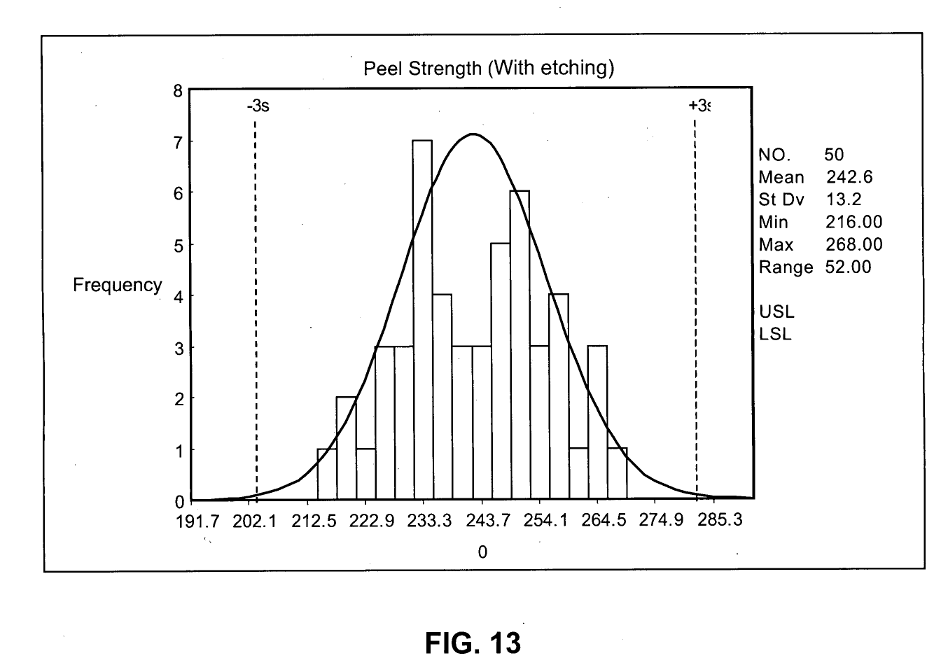

FIG. 12 illustrates peel strength testing data for a prior art micro-actuator without partially etched notches in the side arms, and FIG. 13 illustrates peel strength testing data for the PZT micro-actuator 212 with partially etched notches or dots 270 in the side arms 258, 259. As illustrated, the mean peel strength of 242.6 g of the PZT micro-actuator 212 with partially etched notches is greater than the mean peel strength of 191.4 g of the prior art micro-actuator without partially etched notches. Specifically, the partially etched notches increase the mean peel strength by 51.2 g. In addition, the partially etched notches improve the peel strength range.

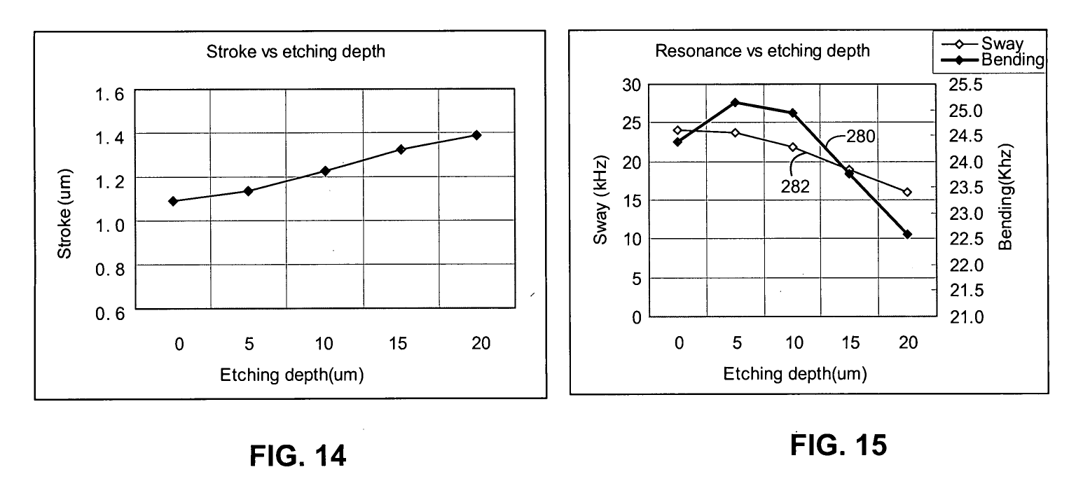

FIG. 14 illustrates testing data of the relationship between micro-actuator stroke and partial etching depth. As illustrated, when the partial etching depth is increased, the micro-actuator stroke will also increase. In addition, when the partial etching depth is increased, the mounting material or epoxy volume will increase which will increase the mounting strength.

FIG. 15 illustrates testing data of the relationship between micro-actuator resonance and partial etching depth. The curve 280 shows the bending frequency and the curve 282 shows the sway frequency. As illustrated, when the partial etching depth is more than about 10 μm, the resonance of both the bending frequency and the sway frequency decreases relatively quickly.

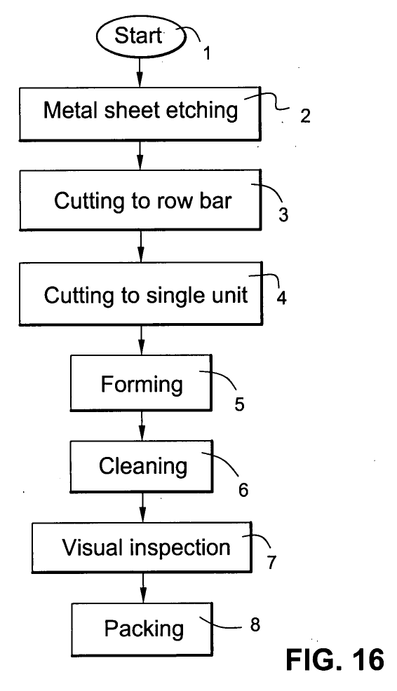

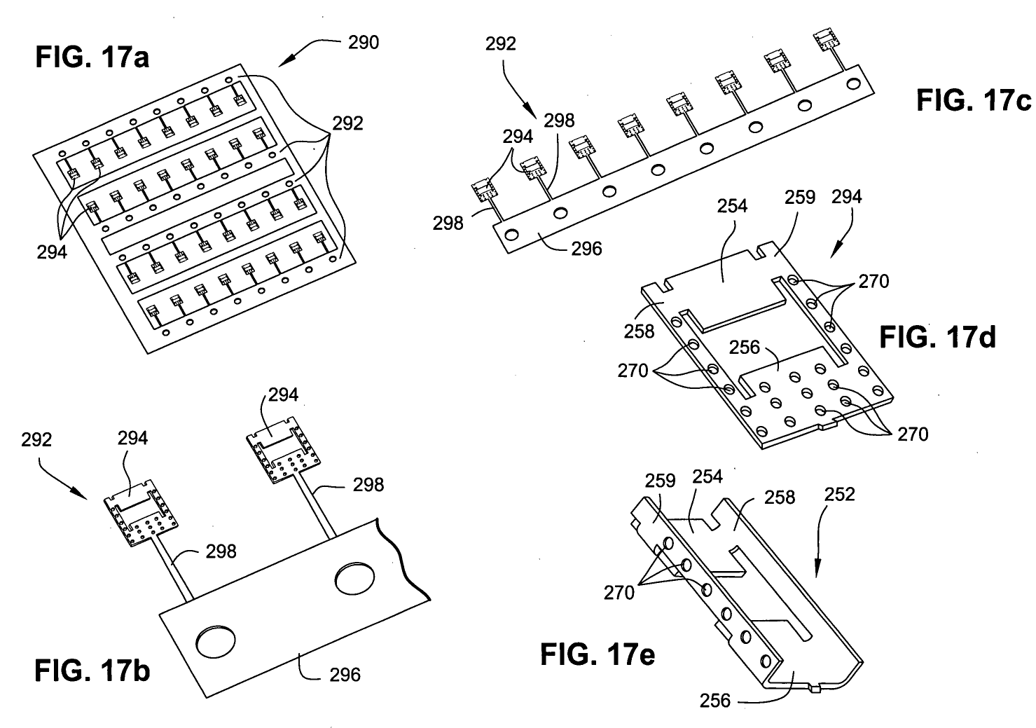

FIGS. 16 and 17a-17e illustrate the primary steps involved in the manufacturing process of the micro-actuator frame 252 according to an embodiment of the present invention. After the process starts (step 1 in FIG. 16), a metal sheet 290 including multiple rows 292, e.g., row bars, of interconnected frame units 294 is formed, e.g., by etching (step 2 in FIG. 16), as shown in FIG. 17a. The metal sheet 290 may be etched by a chemical method through photo-resist.

In the illustrated embodiment, the metal sheet 290 includes four interconnected rows 292, with each row 292 including eight interconnected frame units 294. However, the metal sheet 290 may include other suitable numbers of rows 292 and frame units 294. As best shown in FIG. 17b, each frame unit 294 is coupled to a common base 296 by a beam 298.

Next, as shown in FIG. 17c, a single row bar 292 is cut from the sheet 290 (step 3 in FIG. 16). Then, as shown in FIG. 17d, a single frame unit 294 is cut from the single row bar 292 (step 4 in FIG. 16). As illustrated, the single frame unit 294 includes a top support 254, a bottom support 256, and side arms 258, 259. The bottom support 256 and side arms 258, 259 include multiple partially etched notches 270, which may be etched by one mask. Also, the top support 254 may include multiple partially etched notches 270 (not shown), which may be etched by one mask.

After the single frame unit 294 is cut from the single row bar 292, the single frame unit 294 is formed into a micro-actuator frame 252 of the type described above in FIGS. 8-11 (step 5 in FIG. 16). Specifically, the side arms 258, 259 are vertically bent from opposing sides of the top and bottom supports 254, 256, as shown in FIG. 17e.

After the micro-actuator frame 252 is formed, the micro-actuator frame 252 is cleaned (step 6 in FIG. 16), visually inspected (step 7 in FIG. 16), and packaged (step 8 in FIG. 16) to complete the manufacturing process.

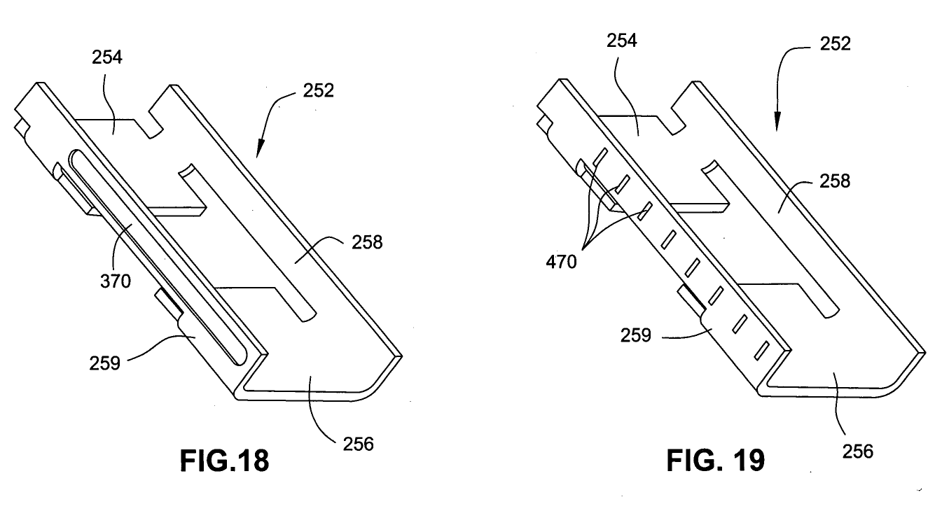

FIGS. 18-21 illustrate micro-actuator frames including partially etched notches according to alternative embodiments of the present invention. The alternative embodiments illustrate alternative shapes and arrangements of the partially etched notches provided to the micro-actuator frame.

In FIG. 18, the partially etched notch 370 provided to each side arm 258, 259 of the frame 252 has an elongated and shallow shape, e.g., linear shape. In FIG. 19, the partially etched notches 470 provided to each side arm 258, 259 of the frame 252 each have a generally square or rectangular shape. However, other suitable shapes are possible.

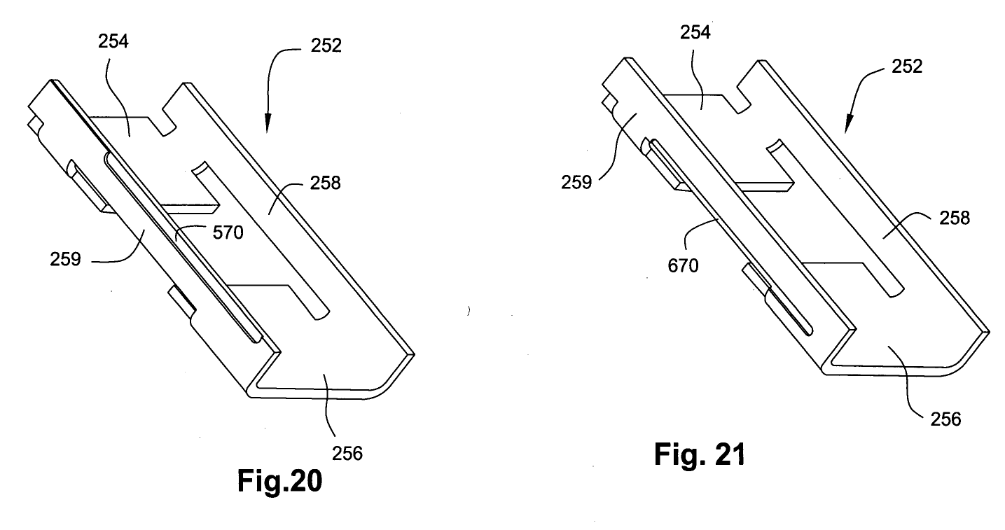

FIG. 20 illustrates an elongated partially etched notch 570 along a top edge of each side arm 258, 259, and FIG. 21 illustrates an elongated partially etched notch 670 along a bottom edge of each side arm 258, 259. In an embodiment, an elongated partially etched notch may be provided at both the top and bottom edge of each side arm 258, 259. This etching arrangement along top and/or bottom edges may improve the peel strength and prevent epoxy overflow during PZT mounting.

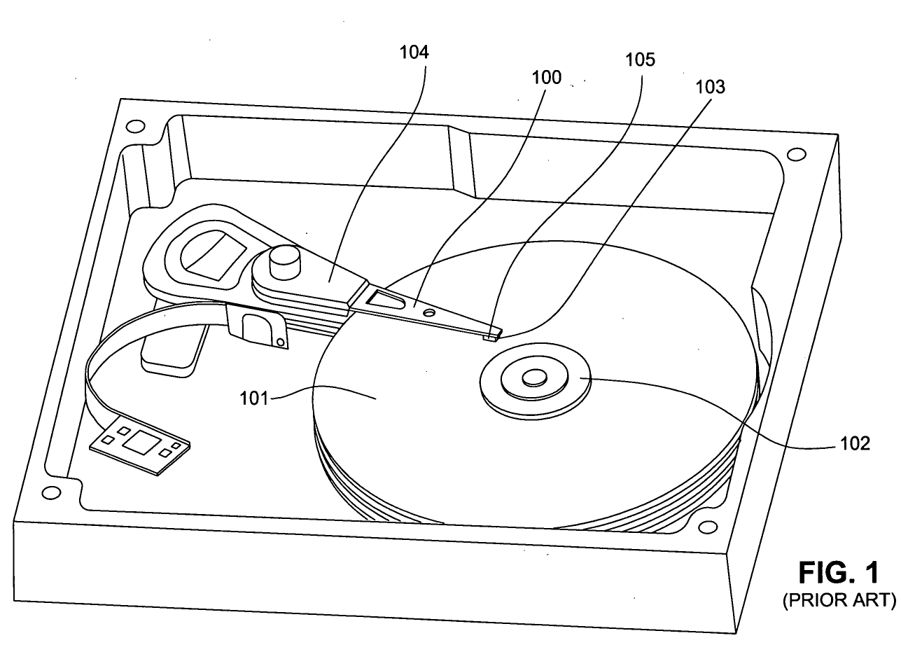

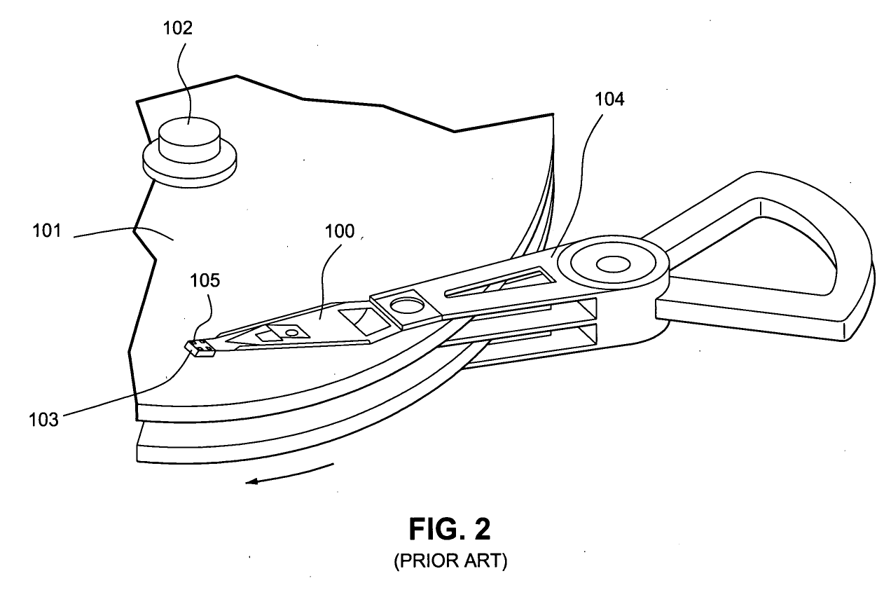

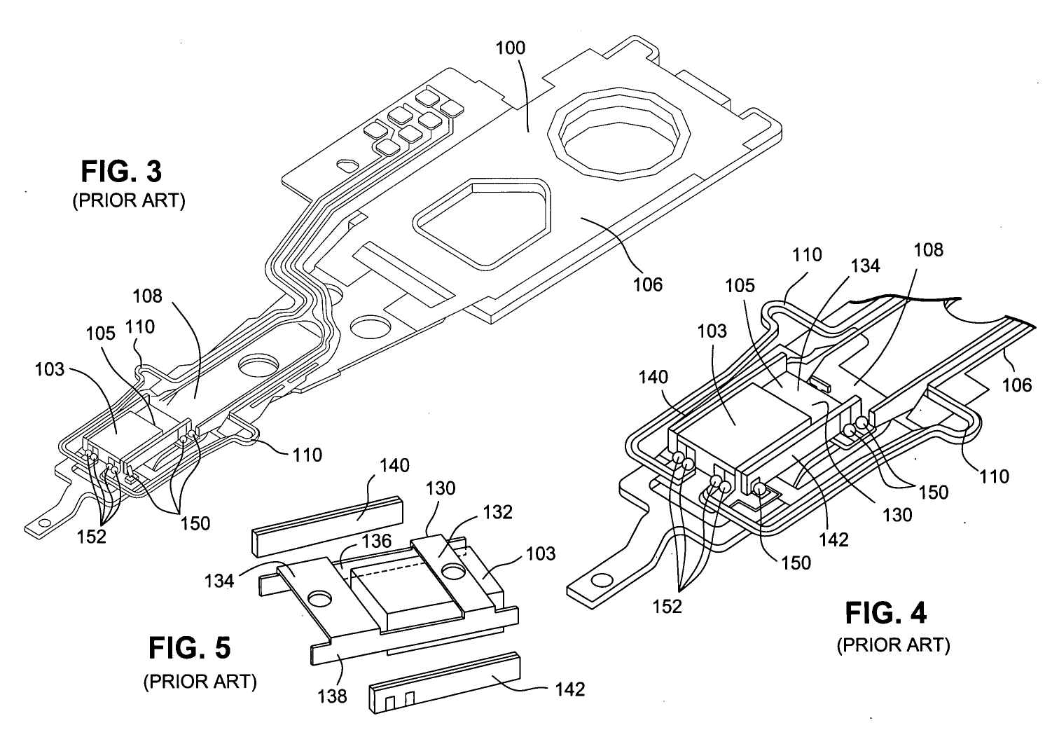

A head gimbal assembly 210 incorporating a PZT micro-actuator 212 according to embodiments of the present invention may be provided to a disk drive device (HDD). The HDD may be of the type described above in connection with FIG. 1. Because the structure, operation and assembly processes of disk drive devices are well known to persons of ordinary skill in the art, further details regarding the disk drive device are not provided herein so as not to obscure the invention.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A micro-actuator for a head gimbal assembly, comprising:
a metal frame including
a top support having a top surface adapted to support a slider,
a bottom support having a bottom surface adapted to be mounted to a suspension, and
a pair of side arms that interconnect the top support and the bottom support, each of the side arms including an outwardly facing surface adapted to be mounted to a PZT element,
wherein the top surface, the bottom surface, and/or the outwardly facing surface includes a partially etched notch.

2. The micro-actuator according to claim 1, wherein the partially etched notch is provided in the outwardly facing surface of each side arm.

3. The micro-actuator according to claim 1, wherein the partially etched notch is provided in the bottom surface of the bottom support.

4. The micro-actuator according to claim 1, wherein the partially etched notch is provided in the top surface of the top support.

5. The micro-actuator according to claim 1, wherein the partially etched notch is provided in the outwardly facing surface of each side arm, in the bottom surface of the bottom support, and in the top surface of the top support.

6. The micro-actuator according to claim 1, wherein the partially etched notch includes multiple spaced apart partially etched notches.

7. The micro-actuator according to claim 6, wherein each partially etched notch is in the form of a dot.

8. The micro-actuator according to claim 6, wherein each partially etched notch has a square or rectangular shape.

9. The micro-actuator according to claim 6, wherein multiple partially etched notches are provided in the outwardly facing surface of each side arm, in the bottom surface of the bottom support, and/or in the top surface of the top support.

10. The micro-actuator according to claim 1, wherein the partially etched notch has a depth of about 1-20 μm.

11. The micro-actuator according to claim 1, wherein the partially etched notch is configured to increase surface roughness to increase mounting strength.

12. The micro-actuator according to claim 1, wherein the partially etched notch has an elongated linear shape.

13. The micro-actuator according to claim 12, wherein the partially etched notch is provided along a top edge of each side arm.

14. The micro-actuator according to claim 12, wherein the partially etched notch is provided along a bottom edge of each side arm.

15. The micro-actuator according to claim 12, wherein the partially etched notch is provided along a top edge and a bottom edge of each side arm.

16. A head gimbal assembly comprising:
a micro-actuator;
a slider; and
a suspension that supports the micro-actuator and the slider,
the micro-actuator includes:
a metal frame including
a top support having a top surface that supports the slider,
a bottom support having a bottom surface mounted to the suspension, and
a pair of side arms that interconnect the top support and the bottom support, each of the side arms including an outwardly facing surface adapted to be mounted to a PZT element,
wherein the top surface, the bottom surface and/or the outwardly facing surface includes a partially etched notch.

17. The head gimbal assembly according to claim 16, wherein the partially etched notch is provided in the outwardly facing surface of each side arm.

18. The head gimbal assembly according to claim 16, wherein the partially etched notch is provided in the bottom surface of the bottom support.

19. The head gimbal assembly according to claim 16, wherein the partially etched notch is provided in the top surface of the top support.

20. The head gimbal assembly according to claim 16, wherein the partially etched notch is provided in the outwardly facing surface of each side arm, in the bottom surface of the bottom support, and in the top surface of the top support.

21. The head gimbal assembly according to claim 16, wherein the partially etched notch includes multiple spaced apart partially etched notches.

22. The head gimbal assembly according to claim 21, wherein each partially etched notch is in the form of a dot.

23. The head gimbal assembly according to claim 21, wherein each partially etched notch has a square or rectangular shape.

24. The head gimbal assembly according to claim 21, wherein multiple partially etched notches are provided in the outwardly facing surface of each side arm, in the bottom surface of the bottom support, and/or in the top surface of the top support.

25. The head gimbal assembly according to claim 16, wherein the partially etched notch has a depth of about 1-20 μm.

26. The head gimbal assembly according to claim 16, wherein the partially etched notch is configured to increase surface roughness to increase mounting strength.

27. The head gimbal assembly according to claim 16, wherein the partially etched notch has an elongated linear shape.

28. The head gimbal assembly according to claim 27, wherein the partially etched notch is provided along a top edge of each side arm.

29. The head gimbal assembly according to claim 27, wherein the partially etched notch is provided along a bottom edge of each side arm.

30. The head gimbal assembly according to claim 27, wherein the partially etched notch is provided along a top edge and a bottom edge of each side arm.

31. A disk drive device comprising:
a head gimbal assembly including a micro-actuator, a slider, and a suspension that supports the micro-actuator and slider;
a drive arm connected to the head gimbal assembly;
a disk; and
a spindle motor operable to spin the disk,
the micro-actuator includes:
a metal frame including
a top support having a top surface that supports the slider,
a bottom support having a bottom surface mounted to the suspension, and
a pair of side arms that interconnect the top support and the bottom support, each of the side arms including an outwardly facing surface adapted to be mounted to a PZT element,
wherein the top surface, the bottom surface, and/or the outwardly facing surface includes a partially etched notch.

32. A method for manufacturing a micro-actuator frame, the method comprising:
forming a metal sheet that includes multiple interconnected row bars with each row bar including multiple interconnected frame units;
cutting a single row bar from the metal sheet;
cutting a single frame unit from the single row bar;
forming the single frame unit into a micro-actuator frame by vertically bending opposing sides of the single frame unit to form side arms;
cleaning the micro-actuator frame;
visually inspecting the micro-actuator frame; and
packing the micro-actuator frame.

33. The method according to claim 32, wherein forming a metal sheet includes forming a metal sheet by etching.

34. The method according to claim 32, wherein forming a metal sheet includes forming partially etched notches in each frame unit.
